(19) United States
(12) Patent Application Publication
(10) Pub. No.: US 2011/0003047 A1
(43) Pub. Date: Jan. 6, 2011

(54) CONTINUOUS COOKING AND MASHING PROCESS

(75) Inventor: Janis Zakis, Mordialloc (AU)

Correspondence Address: STAINBROOK & STAINBROOK, LLP, 412 AVIATION BOULEVARD, SUITE H, SANTA ROSA, CA, 95403, US

(73) Assignee: PULSTAR INTERNATIONAL CORPORATION, Reno, NV (US)

(21) Appl. No.: 12/865,697

(22) PCT Filed: Jan. 30, 2009
(86) PCT No.: PCT/AU2009/000095

§ 371 Date: Jul. 30, 2010

(30) Foreign Application Priority Data
Jan. 30, 2008 (AU) 2008900403

(51) Int. Cl. A23L 1/01; A23L 1/201

(52) U.S. Cl. 426/508

(57) ABSTRACT

A method for the rapid continuous mashing and cooking of grains, legume pulses, corn kernels, seeds or the like, as a stage in the production of a food product, said method including the steps of: introducing said grains, legume pulses, corn kernels or the like into a continuous throughput high-shear mixing/cooking device in which said materials are heated at a pressure of up to 40 Bar and to a temperature of between 100° C. and 200° C. and are then expelled from said device and cooled to a target temperature for storage or further processing.

### FIELD OF THE INVENTION

The invention relates to the field of commercial food processing. In particular, the invention relates to the commercial processing of legume pulses, seeds and the like into food products.

### BACKGROUND OF THE INVENTION

Grain legume pulses and seeds such as corn (maize) are staples of the diet of many communities, due at least in part to their nutritional value. This is often characterised by a high level of dietary fibre, protein and/or carbohydrate. Well-known and used legume pulses in the human food chain include the following:

Dry beans (Phaseolus spp. including several species now in Vigna)

Kidney bean, haricot bean, pinto bean, navy bean (Phaseolus vulgaris)

Lima bean, butter bean (Vigna lunatus)

Azuki bean, adzuki bean (Vigna angularis)

Mung bean, golden gram, green gram (Vigna radiata)

Black gram, Urad (Vigna mungo)

Scarlet runner bean (Phaseolus coccineus)

Rice bean (Vigna umbellata)

Moth bean (Vigna acontifolia)

Tepary bean (Phaseolus acutifolius)

Dry broad beans (Vicia faba)

Horse bean (Vicia faba equina)

Broad bean (Vicia faba)

Field bean (Vicia faba)

Red Pinto Beans (Alubia pinta alavesa)

Dry peas (Pisum spp.)

Garden pea (Pisum sativum var. sativum)

Protein pea (Pisum sativun var. arvense)

Chickpea, Garbanzo, Bengal gram (Cicer arietinum)

Dry cowpea, Black-eyed pea, blackeye bean (Vigna unguiculata ssp. dekindtiana)

Pigeon pea, Toor, cajan pea, congo bean (Cajanus cajan)

Lentil (Lens culinaris)

Bambara groundnut, earth pea (Vigna subterranea)

Vetch, common vetch (Vida sativa)

Lupins (Lupinus spp.)

Minor pulses include:

Lablab, hyacinth bean (Lablab purpureus)

Jack bean (Canavalia ensiformis)

Sword bean (Canavalia gladiata)

Winged bean (Psophocarpus teragonolobus)

Velvet bean, cowitch (Mucuna pruriens var. utilis)

Yam bean (Pachyrrizus erosus)

Corn or maize includes the following:

Flour corn (Zea mays var. amylacea)

Popcorn (Zea mays var. everta)

Dent corn (Zea mays var. indentata)

Flint corn (Zea mays var. indurata)

Sweet corn (Zea mays var. saccharata and Zea mays var. rugosa)

Waxy corn (Zea mays var. ceratina)

Amylomaize (Zea mays)

Pod corn (Zea mays var. tunicata Larrañaga ex A. St. Hil.)

Striped maize (Zea mays var. japonica)

However, one of the difficulties associated in processing these materials into commercial foodstuffs is their tendency to be relatively dry, dense and hard. This makes processing physically difficult. This problem has historically been addressed, whether in domestic or commercial settings, by a process of soaking (or ‘steeping’) in an excess of water, followed by cooking; the process of soaking and cooking being known as ‘mashing’. Mashing is typically carried out in open cookers at a maximum temperature of less that 100° C. The resulting product is not commercially sterile.

The mashing process softens the pulses or corn kernels and increases their overall moisture content as water is imbibed over time. This makes the pulses or kernels softer and somewhat easier to process, especially where size reduction is required, such as the production of hummus from chick peas, corn masa from whole corn for tortilla's or corn chips, or refried beans from pinto beans.

However, there are several disadvantages of the traditional mashing process, especially when scaled up for a high-volume commercial process.

The mashing process tends to be very time-consuming—the pulses or kernels are required to be mashed for between 12 and 72 hours in order to render them usable. In some cases such as the manufacture of corn chips, significant pH adjustment is required using such compounds as calcium hydroxide (CaOH). This adds greatly to the complexity of supply and planning required to process the pulses, as well as leading to a very substantial mass of ‘work-in-progress’ material (WIP) on hand at any given time in the processing plant.

The mashing process is also very water-intensive—for example, approximately 3 kg of water is used per 1 kg of chick peas in a typical hummus manufacturing process. As very little of this water is retained in the final product, a significant portion of the water used in processing is disposed of as waste. This is very undesirable where water is increasingly being regarded as a key resource, and is being priced accordingly, and where the treatment and disposal of waste-water with elevated levels of biological oxygen demand (BOD) is increasingly expensive both in terms of capital investment and ongoing treatment cost. This is particularly important in the production of corn masa, where a significant amount of water, with pH modifiers, is also used in the washing process.

Further to this, the cooking process typically involves the heating of the entire mash (grains, legume pulses, corn kernels or the like plus water). This involves the use of energy to raise the temperature of what may in some formulations shortly become waste water, which represents a significant waste of energy and the cost of providing same.

In the alternative, where a significant proportion of the mash water forms part of the formulation of the final product, such as in a hummus manufacturing process, the investment in energy made in the cooking process for the whole mash must then be dissipated as the cooked mash is cooled for storage or further processing: a process which requires the further input of energy in refrigeration duty. This represents a significant energy inefficiency in heating and then cooling the added water, as only the legume mass requires cooking.

This also opens the opportunity for significant spoilage to occur to WIP product, as mashed legumes or corn tend to be reasonably viscous and therefore difficult to cool efficiently. This may allow significant proportions of the cooling mash to remain at elevated temperatures for extended periods, encouraging microbial outgrowth.

There may also be a very significant investment required on the part of the processor in plant and equipment comprising tanks, piping, pumping boilers and chillers, as well as large factory space.

Accordingly, it is an object of the present invention to provide a method of processing legume pulses, grains, kernels, seeds or the like in a manner which alleviates at least one of the shortcomings of the prior art, including but not limited to providing a processing method which consumes less water, and/or produces less aqueous waste, and/or reduces the amount of WIP on hand, and/or reduces the heating duty during the cooking process and the cooling duty of refrigeration equipment post-cooking, and/or has a significantly reduced average processing time.

### SUMMARY OF THE INVENTION

According to one aspect of the invention, there is provided a method for the rapid continuous mashing and cooking of dry grains, legume pulses, corn kernels or the like, as a stage in the production of a food product, said method including the steps of: introducing said dry grains, legume pulses, corn kernels or the like into a continuous throughput high-shear mixing/cooking device in which said materials are heated at a pressure of up to 40 Bar and to a temperature of between 100° C. and 200° C. and are then expelled from said device and cooled to a target temperature for storage or further processing.

There are a number of advantages presented by the above inventive method when compared with the prior art. Firstly, the use of the continuous throughput high-shear mixing/cooking device allows the grains, legume pulses, corn kernels or the like to be processed whole, with no pre-milling, no preconditioning and no substantial pre-cooking addition of water. The high-shear mixing/cooking device facilitates the breaking open of these materials, and the subsequent heating, at elevated pressure, of these materials in the presence only of naturally occurring water, facilitates effective cooking of the material in a more rapid manner. The resulting mass may also be considered to be commercially sterile.

The process according to the invention removes the need for use of a large water excess, which in turn removes the need to heat the water mass, as well as removing the need to either discard and/or cool the water excess. This also reduces the likelihood of microbial spoilage of a large mass of heated mash.

Removal of the need for a large volume of WIP mash also greatly reduces both the required total WIP and the overall instantaneous processing rate of the manufacture of the food product. For example, in a hummus processing plant utilising the inventive method, the average residence time in processing for a particular element of the final food product would be approximately two hours.

In some applications, where the end product requires significant thermal cooking as compared with shear cooking, or the product will tolerate this cooking procedure, the combination of grains, legume pulses, corn kernels or the like with water may be preheated to a target feed temperature prior to introduction into the high-shear mixing/cooking device. The advantage of this step is that machines can be designed which deliver a very high production capacity, as this step tends to further enhance the efficiency of the cooking in the device, further increasing the instantaneous processing rate possible in the device.

Accordingly, there is provided a method for the rapid continuous mashing and cooking of grains, legume pulses, corn kernels or the like, as a stage in the production of a food product, said method including the steps of: introducing the whole grains, legume pulses, corn kernels or the like to a continuous throughput high-shear mixing/cooking device in which said mixture is heated at a pressure of up to 40 Bar, to a temperature of between 100° C. and 200° C. and is then expelled. The mixture flash cools as it exits the cooker to a temperature of about 95° C., and thereby releases some of the entrained water. This means that the water content drops from 10-12% to 4-6%, resulting in a flour which is likely to be shelf stable when stored in sealed containers. The flour can also be combined with ambient or chilled water to achieve a target overall moisture content or consistency at a desired temperature.

Further advantageously, a continuous throughput mixer may be employed to combine the ambient or chilled water with the output of the high-shear mixing/cooking device, where said water may be metered into said mixer at a constant mass ratio relative to the mass flow rate of said output.

Use of the above described continuous mixing apparatus will further assist in optimising the instantaneous throughput of the inventive process.

In the case of the post-cooking water addition, the ability to continuously add water to meet the food product recipe requirement will allow the relative coolness of ambient (or chilled) water to instantaneously cool the cooked mass as it emerges from the cooking stage. This effectively turns the coolness of the recipe water into a process advantage, in that the duty of the subsequent cooling apparatus is reduced by the low relative temperature of the water, instead of, as is the case in the prior art, requiring the initially cool water to be heated to the cooking temperature of the mass and then cooled again post-cooking.

The inventive method may be applied to many different feed materials as a preparation stage in the manufacture of a wide variety of different commercial food products.

The inventors are aware of a particularly useful application of the method to the preparation of hummus from chick peas. In this particular case, the method is applied as follows:

the legume pulses are chick peas;

the chick peas are cleaned and then fed directly into the cooker;

the target temperature of the chick peas in the high-shear mixing/cooking device is at least 135° C., preferably above 155° C.; and

the addition of ambient or chilled water to the high-shear mixing/cooking device output is controlled at a rate of between 200% and 300% of the mass flow rate of said output.

Another particularly advantageous application of the inventive method of which the inventors are aware is in the preparation of corn masa from corn kernels. In this particular case, the method is applied as follows:

the grains, legume pulses, corn kernels or the like are substantially corn kernels that have been de-hulled;

the target temperature of the corn kernels in the high-shear mixing/cooking device is above 135° C.; and

no post-cooking addition of ambient or chilled water is made.

In another aspect, the invention provides a commercial food product produced by the method as described above.

Now will be described preferred embodiments of the invention, with reference to specific, non-limiting examples.

### DETAILED DESCRIPTION OF A PREFERRED EMBODIMENT

The inventive method, as described above, is applicable to the processing of a wide variety of different grain legume pulses for a wide variety of food products. The following examples represent three particular scenarios in which the inventors have found the inventive method to present advantages over the prior art.

### EXAMPLE 1

### Hummus

This example relates to the preparation of chick peas for subsequent processing into hummus, a ‘dip’-like food which originates in the middle-east, and which is popular in a number of regions.

The chick peas are obtained completely de-hulled and cleaned and are in the form of individual pulses.

The chick peas are then fed into a high-shear cooker. Selection of the precise type of high-shear cooker is not critical to the success of the process.

In this particular example, the high-shear cooker selected is a KS-250 “PULSATOR”, available from KoEx Pty Ltd, of 29 Fonceca Street, Mordialloc VIC 3195 Australia. This machine includes a heated stator, which encloses a rotor adapted to convey material through the stator. The stator may be heated, via such means as steam jacketing, electrical elements or oil jacketing. The conveying rotor is adapted to be able to take chick peas which typically have a diameter of 6-10 mm. The rotor is adapted to push the feed material out through a die-plate.

The stator heating control is set to 130° C.; the rotor speed is set to between 600 and 800 rpm; the die-plate is made with a series of orifices to maximise the surface area. The chick peas are fed into the cooker at approximately 250 kg/hr and emerge from the die orifice at a temperature in the range of 130° C. to 170° C. (depending on cooling control settings) and tend to undergo slight expansion.

The cooked chick pea mass appears as pellets of a ‘pasty’ texture. It may then be fed into a size reducing mill to produce the cooked flour and ground to the particle size required for the hummus product being produced.

At this stage the chick pea flour may be fed into a continuous-throughput mixing device or batch device, into which is metered chilled or ambient temperature water at a mass rate to bring the final mixture to a moisture content of approximately 50 to 75% depending on the recipe.

Use of ambient temperature water for this purpose would concomitantly reduce the temperature of the final mixture to about 20° C. to 30° C., thereby greatly reducing the duty of refrigeration equipment in reducing the temperature of the mass to <4° C. for storage, or obviating the need for further chilling if the mass is to be immediately subsequently mixed with further ingredients to produce the final hummus product for packing.

It also appears that chick pea mass produced according to the above method may have the further advantage of being capable of absorbing more water when formulated as hummus than traditionally manufactured material, resulting in a potential formulation cost advantage per unit finished product.

It is estimated that the above process would have the net effect (when compared with prior art mashing process) of:
reducing the WIP of chick pea mass at any given time;
increasing the instantaneous production rate of final product, potentially by about 270%;
reducing the specific cooking energy consumption (potentially by about 50%);
reducing the specific cooling energy requirement, potentially by about 60%;
reducing potential contamination of the final product;
reducing the factory space required;
allowing the use of lower grade or smaller chickpeas to produce a product normally associated only with premium pulses; and
reducing the amount of water used.

### EXAMPLE 2

### Corn Masa

This example relates to the preparation of whole corn for subsequent processing into masa, with nil water addition.

The corn is obtained completely de-hulled and cleaned and is in the form of individual kernels. In this case, the kernels are not ground, but are fed directly into a high-shear cooker.

In this particular example, whole corn is used to produce corn masa flour. The high-shear cooker selected is a KS-250 “PULSATOR” available from KoEx Pty Ltd, of 29 Fonceca Street, Mordialloc VIC 3195 Australia, as per example 1.

The heating control is set to about 130° C.; the rotor speed is set to between 450 and 600 rpm. The mixture is fed into the cooker at approximately 200 kg/hr, along with any flavour enhancers required, and emerges from the orifice at a temperature of approximately 90° C. to 95° C. and undergoes slight expansion.

The cooked corn mass appears as a dry, pellet-like material, which does not require drying for storage. It may then be fed into a size reducing mill to produce a cooked flour and then ground to the particle size required. A wide variety of masa flours are able to be made according to this method.

It is estimated that the above process would have the net effect (when compared with prior art mashing process) of:
reducing the WIP of corn mass at any given time;
increasing the instantaneous production rate of final product (potentially by about 270%);
reducing the specific cooking energy consumption (potentially by about 50%);
eliminating the need to pre-soak (steep) the corn;
very substantial reduction in the level of water consumed by the process.
   Other advantages provided by the inventive process in the manufacture of corn masa include:
reducing potential contamination of the final product;
reducing the factory space required;
allowing the use of lower grade or cracked corn to produce product of a quality associated with premium kernels;
removing the requirement to use CaOH in the soaking/steeping stage;
substantially reducing the overall amount of water required per unit finished product;
obviating the rinsing stage otherwise required to remove the CaOH;
as the hydration time for the corn masa flour produced by the above method is very short compared with flours made in the more traditional manner, mixing times for products using the corn masa can be substantially reduced; and
using corn masa flour made as described above in the manufacture of corn chips can reduce the level of water in the corn chip formulation, thereby reducing or removing the costs associated with installing and/or running a drying oven in the corn chip process.

As a further enhancement, product in pellet form, from any of the above examples, can be obtained post-cooking and dried and stored for re-hydration at a future date. This would allow long-distance transport of the product at minimum cost and with an enhanced shelf life. Re-hydration, if necessary, would be easily carried out at the destination ready for packing and sale.

It will be appreciated by those skilled in the art that the above examples are merely two applications in which the inventive method can be beneficially utilised. Application of the invention to other grain legume pulses, or to the preparation of same for other commercial food products are well within the skill of the patent addressee.

1-9. (canceled)

10. A method for the rapid continuous mashing and cooking of whole or broken grains, legume pulses, corn kernels, seeds or the like, as a stage in the production of a commercially sterile food product, said method including the steps of: introducing said grains, legume pulses, corn kernels or the like, in a dry state, into a continuous throughput high-shear food extrusion device, in which said materials are heated at a pressure of between 2 Bar and 40 Bar and to a temperature of between 100° C. and 200° C.; then expelled from said device; then milled and cooled for storage or further processing.

11. The method of claim 10, wherein a continuous throughput mixer is employed to combine the ambient or chilled water with the output of the high-shear food extrusion device, and wherein said water is metered into said mixer at a constant mass ratio relative to the mass flow rate of said output.

12. The method of claim 11, wherein the food product is hummus, and wherein:
said grains, legume pulses, corn kernels or the like are substantially chick peas;
the whole chick peas are cleaned and then fed directly into the high-shear food extrusion device;
the target temperature of the chick peas in the high-shear food extrusion device is at least 130° C., preferably above 155° C.;
the milling of the food product to a desired particle size; and
the addition of ambient or chilled water to the high-shear food extrusion device output is controlled at a rate of between 200% and 300% of the mass flow rate of said output.

13. The method of claim 11, wherein the food product is corn masa, and wherein:
said grains, legume pulses, corn kernels or the like are substantially corn kernels that have been de-hulled;
the target temperature of the corn kernels in the high-shear food extrusion device is about 130° C. to 180° C.; and
the milling of the food product to a desired particle size; and
the addition of ambient or chilled water to the high-shear food extrusion device output is controlled at a rate of between 30% and 60% of the mass flow rate of said output.

14. The method of claim 10, further including the steps of:
combining the output of the extrusion device with ambient or chilled water to achieve a target overall moisture content or consistency; and
cooling the mixture to a target temperature for storage or further processing.

15. The method of claim 14, wherein a continuous throughput mixer is employed to combine the ambient or chilled water with the output of the high-shear food extrusion device, and wherein said water is metered into said mixer at a constant mass ratio relative to the mass flow rate of said output.

16. A method for the rapid continuous mashing and cooking of whole or broken grains, legume pulses, corn kernels, seeds or the like, as a stage in the production of a food product, said method including the steps of: introducing said grains, legume pulses, corn kernels or the like, in a dry state, into a continuous throughput high-shear food extrusion device, in which said mixture is heated at a pressure of between 2 Bar and 40 Bar, and to a temperature of between 100° C. and 200° C. and are then expelled as a dry pellet, having a moisture content of 12% or less.

17. The method of claim 16, further including the steps of:
combining the output of the extrusion device with ambient or chilled water to achieve a target overall moisture content or consistency; and
cooling the mixture to a target temperature for storage or further processing.

18. The method of claim 17, wherein a continuous throughput mixer is employed to combine the ambient or chilled water with the output of the high-shear food extrusion device, and wherein said water is metered into said mixer at a constant mass ratio relative to the mass flow rate of said output.

19. The method of claim 18, wherein the food product is hummus, and wherein:
said grains, legume pulses, corn kernels or the like are substantially chick peas;
the whole chick peas are cleaned and then fed directly into the high-shear food extrusion device;
the target temperature of the chick peas in the high-shear food extrusion device is at least 130° C., preferably above 155° C.;
the milling of the food product to a desired particle size; and
the addition of ambient or chilled water to the high-shear food extrusion device output is controlled at a rate of between 200% and 300% of the mass flow rate of said output.

20. The method of claim 18, wherein the food product is corn masa, and wherein:
said grains, legume pulses, corn kernels or the like are substantially corn kernels that have been de-hulled;
the target temperature of the corn kernels in the high-shear food extrusion device is about 130° C. to 180° C.; and
the milling of the food product to a desired particle size; and
the addition of ambient or chilled water to the high-shear food extrusion device output is controlled at a rate of between 30% and 60% of the mass flow rate of said output.

21. The method of claim 16, wherein a continuous throughput mixer is employed to combine the ambient or chilled water with the output of the high-shear food extrusion device, and wherein said water is metered into said mixer at a constant mass ratio relative to the mass flow rate of said output.

22. The method of claim 21, wherein the food product is hummus, and wherein:
said grains, legume pulses, corn kernels or the like are substantially chick peas;
the whole chick peas are cleaned and then fed directly into the high-shear food extrusion device;
the target temperature of the chick peas in the high-shear food extrusion device is at least 130° C., preferably above 155° C.;
the milling of the food product to a desired particle size; and
the addition of ambient or chilled water to the high-shear food extrusion device output is controlled at a rate of between 200% and 300% of the mass flow rate of said output.

23. The method of claim 21, wherein the food product is corn masa, and wherein:
said grains, legume pulses, corn kernels or the like are substantially corn kernels that have been de-hulled;
the target temperature of the corn kernels in the high-shear food extrusion device is about 130° C. to 180° C.; and
the milling of the food product to a desired particle size; and
the addition of ambient or chilled water to the high-shear food extrusion device output is controlled at a rate of between 30% and 60% of the mass flow rate of said output.
